(19) United States
(12) Patent Application Publication
(10) Pub. No.: US 2010/0324924 A1
(43) Pub. Date: Dec. 23, 2010

(54) Medical Billing Systems and Methods

(76) Inventor: David Frederiksen, Nashville, TN (US)

Correspondence Address: PATENTBEST, 4600 ADELINE ST., #101, EMERYVILLE, CA, 94608, US

(21) Appl. No.: 12/589,542

(22) Filed: Jun. 22, 2009

(51) Int. Cl. G06Q 50/00; G06Q 30/00; G06Q 90/00; G06Q 40/00

(52) U.S. Cl. 705/2; 705/500

(57) ABSTRACT

The invention relates to medical billing systems, software, and methods. In the methods, a patient is told how much he or she owes to a hospital prior to or after discharge. The hospital then sells the right to collect the patient debt to a billing service. The billing service establishes an ad hoc credit rating for the hospital by analyzing an existing credit rating scale and fitting the hospital's financial data to that rating scale, and also establishes the patient's credit rating, expected recovery index (ERI) or other scoring metric. The hospital is advanced an amount that depends on the hospital's credit rating and the patient's credit scoring metric, and the billing service collects the debt from the patient, typically by regular automatic transactions. The billing service may interact with patients and hospitals through automated interfaces, and in some embodiments, may act as an affiliate of a health insurer.

### BACKGROUND OF THE INVENTION

1. Field of the Invention

The invention relates to systems and methods for medical billing.

2. Description of Related Art

In a typical medical billing scenario in the United States, for example, when a hospital treats a patient with private insurance, the patient is discharged from the hospital without knowing anything about what he or she will be charged for the hospital visit. The hospital then files a claim with the patient's insurance, which typically pays some portion of the bill, forces the hospital to write-off any portion of the bill that exceeds contractually agreed-upon amounts for each individual treatment, and directs the hospital to recover any remaining balance directly from the patient. Once the insurance payment is determined, the hospital then bills the patient for the remaining balance, if any.

This very common billing scenario has a number of distinct disadvantages, chief among them being that the patient has no idea what he or she will be billed for services, and the hospital may have only a slightly better idea what it will ultimately be paid. Moreover, there are so many different health insurance plans, each with its own procedures and list of covered treatments, that administering this sort of system burdens both the hospital, which must hire staff and maintain very sophisticated billing systems, and the patient, who must deal with a bill for an unknown and unpredictable amount of money. However, despite its shortcomings and the administrative burdens it imposes, this typical billing scenario has survived as hospitals have adapted to it and have become adept at dealing with the health insurance companies that have traditionally been the primary payers of health care costs.

In recent years, as medical costs have gone up, populations have increased, and the number of insured has increased, insurance coverage has become less comprehensive and insurance companies have become more risk-averse. In today's healthcare market, even when a procedure is covered, an insurance company may require the patient to shoulder more of the cost. Therefore, instead of, for example, a $15 co-pay for a procedure, the patient may be asked to pay 30% of the contractually agreed-upon cost for a procedure; thus, the patient's costs may add up to hundreds or thousands of dollars.

This poses problems for the entire system. Patients are given little or no opportunity to plan and budget for the costs of medical care, and are often not able to pay a bill for hundreds or thousands of dollars when it is presented to them. Hospitals, having adapted to a system in which the insurance companies are the primary payers, often do not have the systems, procedures, or staffing to pursue individual patients for payment. Therefore, many patient bills are simply not paid, which may damage the credit rating of the patients, and puts great financial strains on the hospitals as they continue to provide care to other patients.

### SUMMARY OF THE INVENTION

One aspect of the invention relates to a hospital billing method. In the method, a patient is told how much he or she owes to a hospital, preferably prior to discharge. The hospital then sells the right to collect the patient debt to a billing service. The billing service establishes an ad hoc credit rating for the hospital by analyzing an existing credit rating scale and fitting the hospital's financial data to that rating scale, and also establishes the patient's credit rating. The hospital is advanced an amount that depends on the hospital's credit rating and the patient's credit rating, and the billing service collects the debt from the patient, typically by regular automatic transactions.

Another aspect of the invention relates to a system for performing methods such as that described above. The system may provide automated interfaces for gathering patient information from hospitals and for allowing a patient to check and modify payment information and make payments. Communication and transactions may take place over a communication network.

Yet another aspect of the invention relates to a system for medical billing. In the system, a health insurer provides reimbursement to a hospital for covered medical expenses, and a billing service, acting as an affiliate of the health insurer, collects payment from the patient and provides advances and payments to the hospital. The advances and payments to the hospital may be based, at least in part, on an ad hoc credit rating for the hospital and on a credit rating for the patient. The ad hoc credit rating for the hospital may be established by analyzing an existing credit rating scale and fitting the hospital's financial data to that rating scale.

Other aspects, features, and advantages of the invention will be set forth in the description that follows.

### BRIEF DESCRIPTION OF THE DRAWINGS

The invention will be described with respect to the following drawing figures, in which like numerals represent like features throughout the figures, and in which:

FIG. 1 is a flow diagram of a hospital patient billing method according to one embodiment of the invention;

FIG. 2 is a flow diagram of certain tasks in the method of FIG. 1;

FIG. 3 is a graph illustrating the relationship between a financial metric and a credit rating scale;

FIG. 4 is an illustration of a system that may be used to implement the method of FIG. 1; and

FIG. 5 is an illustration of another system that may be used to implement methods according to embodiments of the invention.

### DETAILED DESCRIPTION

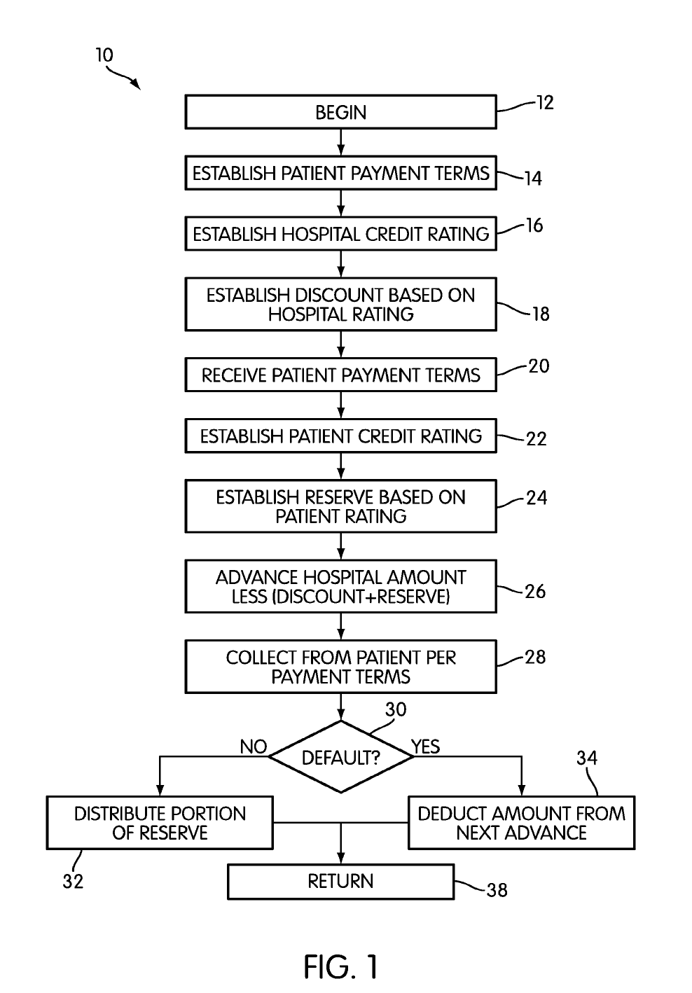

FIG. 1 is a schematic flow diagram of a hospital patient billing method, generally indicated at 10. Although described as a hospital patient billing method, it should be understood that method 10 can be used with hospitals, medical and surgical clinics, doctors' offices, and other medical establishments and medical providers; thus, the term “hospital” is used as a matter of convenience and should be read to include all applicable forms of medical establishments and medical providers.

Method 10 begins with task 12. Generally speaking, method 10 would be initiated at or around the time a patient is discharged from a hospital. At that time, as indicated in task 14, the hospital would typically inform the patient of how much he or she owes for the hospital visit. In different embodiments, this may be done in different ways. For example, commercially available software packages and/or services may be used to estimate the amount the patient will owe based on the patient's individual health insurance plan, any available discounts or deductibles, and any other billing-relevant circumstances.

In method 10 and other methods according to embodiments of the invention, the hospital would generally seek to recover the portion of the bill for which the patient is not responsible directly from the insurance company and, in most embodiments, only the portion of the bill for which the patient is directly responsible would be the subject of method 10. Of course, if the patient is uninsured, he or she may be personally responsible for all or substantially all of the bill.

However, the method by which the hospital decides what the patient owes is not critical to method 10 and may be done in any manner. Thus, for example, the hospital may choose to give individual patients discounts, may forgive some portion of what a patient would otherwise owe, or may decide to charge a premium over the usual cost of services, at its discretion. In addition to informing the patient of the total amount owed before the patient leaves the hospital, the hospital may also negotiate payment terms with the patient (e.g., a specific amount of money to be paid per month for a specified number of months). As will be described below in more detail, once the amount that a patient owes is determined, the patient's account is turned over to a billing service for collection.

In method 10, the billing service acquires the right to collect the amount owed from the patient, and in return for that right, advances the hospital some portion of the total amount owed by the patient. As will be explained below in greater detail, the amount advanced to the hospital in exchange for the right to collect the patient debt depends on a discount amount established based on the hospital's credit rating and a reserve amount established based on the individual patient's credit rating.

A credit rating is an indication, usually based on some predefined, commonly accepted scale, of an institution's creditworthiness. Credit ratings are typically established for commercial debt purposes by one of the major credit rating companies, such as Moody's Investors Service, or Fitch, and, in general, describe the degree of risk associated with investing in the rated entity's securities and debt obligations. Any credit rating scale may be used in embodiments of the invention, although it is generally helpful to use a recognized, established rating scale.

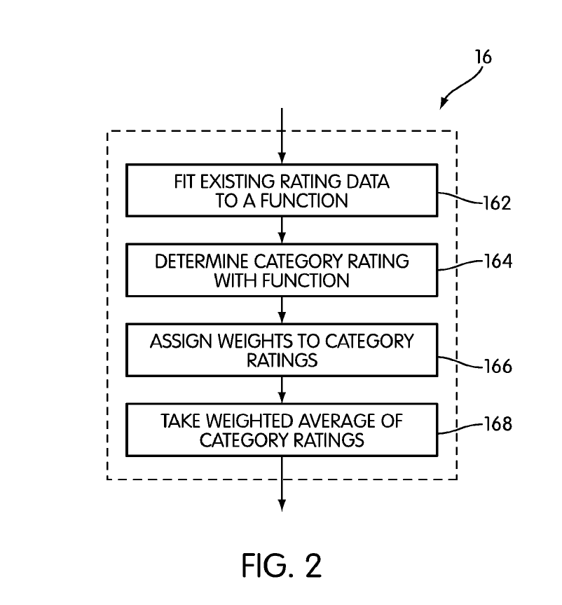

Method 10 continues with task 16, in which a hospital credit rating is established. One difficulty with traditional credit rating methods is that establishing a credit rating is typically an expensive, time-consuming process. Moreover, relatively few hospitals have formal credit ratings, because, for example, debt for a community hospital is often issued in the name of the county or county health department that operates the hospital. Task 16 of method 10 provides a method of establishing an ad hoc credit rating by fitting hospital financial data to an existing credit rating scale. Task 16 may involve a number of sub-tasks, some of which are illustrated in more detail in the flow diagram of FIG. 2. It should be understood that task 16 may be performed on a general purpose or special purpose computer, or on an integrated system, and may be embodied in one or more sets of machine-readable instructions encoded on a machine-readable medium interoperable with a machine to perform the described functions.

Task 16 begins with sub-task 162, in which existing rating data is fitted to a descriptive function. Typically, ratings and rating scales are published and revised at regular intervals. Rating data usually indicates the rating scale and the mean or median value of a financial metric that corresponds to each rating on the scale. For example, the data in Table 1 below is taken from Moody's “2004 Not-for-Profit Freestanding Hospital and Single-State Key Ratio Medians.”

TABLE 1
Exemplary Rating Scale Data

| | Rating | | | | | | | | | |
|---|---|---|---|---|---|---|---|---|---|---|
| | Aa2 | Aa3 | A1 | A2 | A3 | Baa1 | Baa2 | Baa3 | Ba | B |
| | AA | AA− | A+ | A | A− | BBB+ | BBB | BBB− | BB | B |
| | Sample Size | | | | | | | | | |
| Key Ratios | 8 | 32 | 43 | 61 | 64 | 47 | 42 | 24 | 16 | 7 |
| 1. Operating cash flow margin | 11.3% | 10.9% | 9.8% | 9.7% | 9.4% | 7.9% | 6.9% | 6.3% | 4.7% | 4.7% |
| 2. Cash on hand (days) | 239.2 | 224.9 | 174.6 | 171.4 | 141.5 | 119.5 | 94.4 | 78.8 | 56.2 | 25.7 |
| 3. Debt-to-cash flow (x) | 1.8 | 3.3 | 3.4 | 3.6 | 4.3 | 5.2 | 6.2 | 6.6 | 9.9 | 14.1 |
| 4. Max annual debt svc coverage (x) | 8.4 | 4.8 | 4.6 | 4.2 | 3.6 | 3 | 2.6 | 2.3 | 1.6 | 1.2 |
| 5. Debt-to-capitalization | 24.0% | 35.3% | 39.4% | 37.6% | 45.3% | 47.7% | 51.9% | 56.2% | 64.9% | 78.8% |
| 6. Bad debt as % of net patient rev | 5.5% | 6.3% | 5.5% | 5.6% | 6.3% | 5.8% | 5.9% | 6.6% | 6.5% | 13.8% |
| 7. Cash to debt | 201.3% | 146.2% | 114.6% | 106.5% | 84.3% | 77.9% | 55.0% | 50.0% | 36.9% | 20.4% |
| 8. Operating margin | 3.0% | 3.3% | 3.1% | 2.0% | 1.8% | 0.7% | −0.1% | −0.4% | −0.9% | −4.8% |
| 9. Return on assets | 5.2% | 5.2% | 5.1% | 4.0% | 3.5% | 2.6% | 1.2% | 1.2% | 0.6% | −4.2% |
| 10. Cushion ratio (x) | 34.7 | 20 | 14.8 | 13.7 | 9.8 | 10.5 | 5.8 | 5.4 | 5.1 | 2.1 |
| 11. Excess margin | 7.4% | 7.3% | 5.1% | 4.6% | 4.1% | 2.3% | 1.3% | 0.9% | 0.3% | −3.8% |

Table 1 sets forth 11 “key ratios” or financial metrics on which the rating scale is based. In the illustrated example, the rating scale ranges from Aa2/AA, the best rating, to B/B, the worst rating. For each rating, Table 1 shows the median value of a financial metric for that rating. In the example of Table 1, a hospital with the financial metrics as good or better than those in the Aa2/AA column would likely be assigned that rating, a hospital with financial metrics as good or better than those in the Aa3/AA-column would likely be assigned that rating, and so forth.

In sub-task 162, the data from a dataset like that of Table 1 is fitted to a mathematical function, such that each “key ratio” or financial metric is assigned a descriptive function that relates financial metric values to rating scale values. Existing financial data may be assigned to a descriptive function in any number of ways, depending on the nature of the data. One way to fit the data to a descriptive function is by regression analysis.

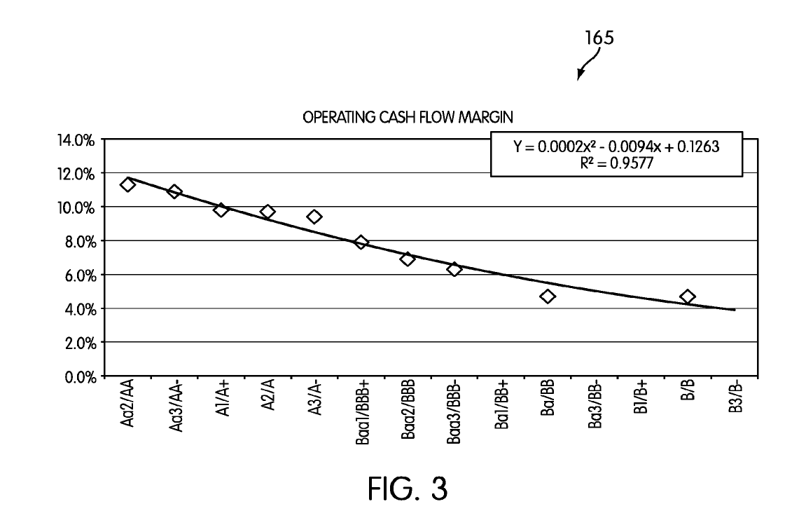

As one example, FIG. 3 is a graph 163 illustrating the rating vs. operating cash flow data from Table 1. Generally, when constructing functions in sub-task 162, each non-numerical rating would be assigned a numerical value. For example, a rating of Aa2/AA would be assigned a value of 1, a rating of Aa3/AA− would be assigned a value of 2, and so forth for each possible rating. In the graph of FIG. 3, the rating scale is along the abscissa (i.e., the X-axis), while the median financial metric value for that rating is along the ordinate (i.e., the Y-axis), although that need not be the case in all embodiments. FIG. 3 also illustrates a regression curve 165 (i.e., a descriptive function) that fits the data. The regression curve in FIG. 3 has the equation y=0.0002x²−0.0094x+0.1263.

Table 2 shows the equation of the descriptive function or trend line for each financial metric in Table 1, along with an r-squared value for each function, which is an indicator of how well the indicated function fits the data, with values closer to 1 indicating a better fit. The functions in Table 2 vary in type, ranging from parabolic to logarithmic and exponential functions. Essentially any type of function may be chosen, depending on the nature of the data that it is to fit. When choosing descriptive functions, one generally tries to choose a function that maximizes the r-squared value.

It should be understood that although the term “function” is used in this description, the equations or curves used to relate the rating scales and financial metrics in task 162 need not necessarily fit the mathematical definition of a function. Any mathematical description of the relationship between a financial metric and a rating scale that fits the data may be used.

TABLE 2
Descriptive Functions for Each Metric

| | | R-Squared |
|---|---|---|
| Ratio | Descriptive Function | Value |
| 1. Operating cash flow | y = 0.0002x² − 0.0094x + | 0.9577 |
| margin | 0.1263 | |
| 2. Cash on hand (days) | y = 329.05e^{-0.1837x} | 0.9815 |
| 3. Debt-to-cash flow (x) | y = 0.0592x² + 0.1515x + | 0.9903 |
| | 2.1476 | |
| 4. Maximum annual | y = 7.6301e^{-0.1499x} | 0.9635 |
| debt service coverage | | |
| (x) | | |
| 5. Debt-to-capitalization | y = 0.0001x² + 0.04x + 0.2383 | 0.9790 |
| 6. Bad debt as a percent of | y = 0.001x² − 0.0091x + 0.0727 | 0.8737 |
| net patient revenue | | |
| 7. Cash to debt | y = −0.7018Ln(x) + 1.979 | 0.9934 |
| 8. Operating margin | y = −0.0003x² − 0.0025x + | 0.9673 |
| | 0.0362 | |
| 9. Return on assets | y = −0.0004x² − 0.0027x + | 0.9656 |
| | 0.0573 | |
| 10. Cushion ratio (x) | y = 32.142e^{-0.2101x} | 0.9514 |
| 11. Excess margin | y = 6E−05x² − 0.01x + 0.0855 | 0.9727 |

Once sub-task 162 is complete, task 16 continues with sub-task 164, in which the hospital's financial data are plugged into the functions established in sub-task 162 to find a category rating for each financial metric. With the ordinate and abscissa defined as they are above and in FIG. 3, it may first be useful to manipulate the descriptive functions so that one can plug in a financial metric value and obtain a corresponding rating value. In other words, it may be useful to manipulate equations like those in Table 2 so that they are in the form “x= . . . ” instead of the form in which they appear in Table 2. That can be done with elementary mathematical operations, depending on the type of function. Alternatively, in some circumstances, the equations may be solved using numerical, rather than algebraic, methods.

For example, using the rating scale set forth in Table 1 above and the descriptive functions for that rating scale that are set forth in Table 2, a hospital having the financial metrics set forth in Table 3 would have the raw numerical ratings set forth in Table 4.

TABLE 3
Exemplary financial metric data for a hospital to be rated.

| | HISTORICAL | | PROJECTED | | | | |
|---|---|---|---|---|---|---|---|
| Ratios | FY02 | FY03 | FY04 | FY05 | FY06 | FY07 | FY08 |
| Operating cash flow margin | 13.9% | 7.7% | 7.1% | 6.6% | 7.6% | 8.3% | 8.2% |
| Cash on hand (days) | 64.9 | 71.2 | 31.4 | 43.4 | 47.9 | 53.9 | 60.2 |
| Debt-to-cash flow (x) | 1.5 | 2.8 | 8.1 | 7.8 | 7.1 | 6.2 | 5.7 |
| Max annual debt svc coverage (x) | 8.0 | 4.6 | 1.6 | 1.6 | 2.1 | 2.5 | 2.6 |
| Debt-to-capitalization | 31.5% | 29.6% | 53.3% | 51.1% | 49.3% | 47.9% | 46.5% |
| Bad debt as % of net pat rev | 14.9% | 12.9% | 12.8% | 12.9% | 12.8% | 12.8% | 13.0% |
| Cash to debt | 74.0% | 90.9% | 15.1% | 22.9% | 28.1% | 34.2% | 41.3% |
| Operating margin | 8.0% | 1.3% | 1.4% | 1.3% | 0.4% | 0.3% | 0.2% |
| Return on assets | 12.2% | 2.5% | 1.8% | 1.7% | 0.8% | 0.9% | 0.8% |
| Cushion ratio (x) | 8.8 | 10.9 | 1.8 | 2.7 | 3.4 | 4.1 | 4.9 |
| Excess margin | 8.7% | 1.9% | 1.9% | 1.7% | 0.8% | 0.8% | 0.7% |

TABLE 4
Raw numerical ratings of the hospital with the data of Table 3.

| | HISTORICAL | | PROJECTED | | | | |
|---|---|---|---|---|---|---|---|
| Ratios | FY02 | FY03 | FY04 | FY05 | FY06 | FY07 | FY08 |
| Operating cash flow margin | 1.0 | 6.1 | 6.9 | 7.7 | 6.1 | 5.2 | 5.3 |
| Cash on hand (days) | 8.8 | 8.3 | 12.8 | 11.0 | 10.5 | 9.9 | 9.2 |
| Debt-to-cash flow (x) | 1.0 | 2.4 | 8.8 | 8.5 | 8.0 | 7.1 | 6.6 |
| Max annual debt svc coverage (x) | 1.0 | 3.4 | 10.5 | 10.3 | 8.7 | 7.5 | 7.1 |
| Debt-to-capitalization | 1.9 | 1.4 | 7.2 | 6.7 | 6.3 | 5.9 | 5.6 |
| Bad debt as % of net patient rev | 14.4 | 13.3 | 13.2 | 13.3 | 13.3 | 13.3 | 13.4 |
| Cash to debt | 5.8 | 4.6 | 13.5 | 12.1 | 11.2 | 10.3 | 9.3 |
| Operating margin | 1.0 | 5.6 | 5.3 | 5.6 | 7.1 | 7.1 | 7.2 |
| Return on assets | 1.0 | 6.2 | 7.1 | 7.2 | 8.2 | 8.2 | 8.2 |
| Cushion ratio (x) | 6.1 | 5.2 | 13.7 | 11.7 | 10.7 | 9.8 | 8.9 |
| Excess margin | 1.0 | 7.0 | 6.9 | 7.1 | 8.2 | 8.2 | 8.2 |

As was explained above, in creating descriptive functions in task 162, ratings on an alphabetical or other than numerical scale are assigned numerical values. Thus, when financial metric data is plugged into the various descriptive functions, the result is a set of numerical values, like that of Table 4. The final task in assigning a rating for each category lies in correlating the numerical values determined from the descriptive functions with a rating on the rating scale. If that is done for the data in Table 4, the resulting category ratings for the hospital are as shown in Table 5.

TABLE 5
Category ratings based on the data of Table 4.

| | HISTORICAL | | PROJECTED | | | | |
|---|---|---|---|---|---|---|---|
| Ratios | FY02 | FY03 | FY04 | FY05 | FY06 | FY07 | FY08 |
| Operating cash flow margin | Aa2/AA | Baa1/BBB+ | Baa2/BBB | Baa3/BBB− | Baa1/BBB+ | A3/A− | A3/A− |
| Cash on hand (days) | Ba1/BB+ | Baa3/BBB− | B2/B | Ba3/BB− | Ba3/BB− | Ba2/BB | Ba1/BB+ |
| Debt-to-cash flow (x) | Aa2/AA | Aa3/AA− | Ba1/BB+ | Ba1/BB+ | Baa3/BBB− | Baa2/BBB | Baa2/BBB |
| Max annual debt svc coverage (x) | Aa2/AA | A1/A+ | Ba3/BB− | Ba2/BBB | Ba1/BB+ | Baa3/BBB− | Baa2/BBB |
| Debt-to-capitalization | Aa3/AA− | Aa2/AA | Baa2/BBB | Baa2/BBB | Baa1/BBB+ | Baa1/BBB+ | Baa1/BBB+ |
| Bad debt as % of net patient rev | B3/B− | B2/B | B2/B | B2/B | B2/B | B2/B | B2/B |
| Cash to debt | Baa1/BBB+ | A3/A− | B3/B− | B1/B+ | Ba3/BB− | Ba2/BB | Ba1/BB+ |
| Operating margin | Aa2/AA | Baa1/BBB+ | A3/A− | Baa1/BBB+ | Baa2/BBB | Baa2/BBB | Baa2/BBB |
| Return on assets | Aa2/AA | Baa1/BBB+ | Baa2/BBB | Baa2/BBB | Baa3/BBB− | Baa3/BBB− | Baa3/BBB− |
| Cushion ratio (x) | Baa1/BBB+ | A3/A− | B3/B− | B1/B+ | Ba3/BB− | Ba2/BB | Ba1/BB+ |
| Excess margin | Aa2/AA | Baa2/BBB | Baa2/BBB | Baa2/BBB | Baa3/BBB− | Baa3/BBB− | Baa3/BBB− |

The raw numerical category ratings may be correlated to ratings on the rating scale using any known technique. In many cases, for example, the numerical rating may be rounded up or down to correlate it with a non-numerical rating value. Thus, when sub-task 164 is complete, the result is a group of category ratings for a number of metrics. Although certain financial metrics are shown in the tables above, a hospital may be rated on any number of financial metrics.

As those of skill in the art will realize, although any number of financial metrics may be useful in assessing a hospital's creditworthiness, some metrics may be more important than others. For that reason, in sub-task 166 of task 16, the category ratings are weighted to establish their overall importance. In different embodiments, the different financial metrics may be weighted in different ways, depending on the nature of the financial metrics and the preferences and experience of the billing service. Given the financial metrics in the above tables, in one embodiment, they might be weighted as follows:

TABLE 6
Financial metric weights.

| Ratios | Weight |
|---|---|
| 1. Operating cash flow margin | 20.0% |
| 2. Cash on hand (days) | 15.0% |
| 3. Debt-to-cash flow (x) | 15.0% |
| 4. Max annual debt svc coverage (x) | 15.0% |
| 5. Debt-to-capitalization | 10.0% |
| 6. Bad debt as % of net patient rev | 5.0% |
| 7. Cash to debt | 5.0% |
| 8. Operating margin | 5.0% |
| 9. Return on assets | 5.0% |
| 10. Cushion ratio (x) | 4.5% |
| 11. Excess margin | 0.5% |
| TOTAL | 100.0% |

As shown in Table 6, this exemplary set of weights places particular emphasis on operating cash flow margin, assigning it a weight of 20% or ⅕ of the total rating. Weights of 15% are assigned to cash on hand, debt-to-cash flow, and maximum annual debt service coverage. The rest of the financial metrics are assigned lesser weights. Given those weights, task 16 continues with sub-task 168, in which the weighted average of the category ratings is taken in order to establish the final credit rating for the hospital. Those weighted average values are then converted into non-numerical ratings. Using the example above, the final ratings for the hospital are set forth in Table 7 below.

TABLE 7
Final weighted credit ratings for each fiscal year.

| | HISTORICAL | | PROJECTED | | | | | |
|---|---|---|---|---|---|---|---|---|
| Ratios | FY02 | FY03 | FY04 | FY05 | FY06 | FY07 | FY08 | Weight |
| Operating cash flow margin | 0.20 | 1.22 | 1.38 | 1.54 | 1.22 | 1.04 | 1.06 | 20.0% |
| Cash on hand (days) | 1.32 | 1.25 | 1.92 | 1.65 | 1.58 | 1.49 | 1.38 | 15.0% |
| Debt-to-cash flow (x) | 0.15 | 0.36 | 1.32 | 1.28 | 1.20 | 1.07 | 0.99 | 15.0% |
| Max annual debt svc cvrg (x) | 0.15 | 0.51 | 1.58 | 1.55 | 1.31 | 1.13 | 1.07 | 15.0% |
| Debt-to-capitalization | 0.19 | 0.14 | 0.72 | 0.67 | 0.63 | 0.59 | 0.56 | 10.0% |
| Bad debt as % of net pat rev | 0.72 | 0.67 | 0.66 | 0.67 | 0.67 | 0.67 | 0.67 | 5.0% |
| Cash to debt | 0.29 | 0.23 | 0.68 | 0.61 | 0.56 | 0.52 | 0.47 | 5.0% |
| Operating margin | 0.05 | 0.28 | 0.27 | 0.28 | 0.36 | 0.36 | 0.36 | 5.0% |
| Return on assets | 0.05 | 0.31 | 0.36 | 0.36 | 0.41 | 0.41 | 0.41 | 5.0% |
| [symbol] . Cushion ratio (x) | 0.27 | 0.23 | 0.62 | 0.53 | 0.48 | 0.44 | 0.40 | 4.5% |
| [symbol] . Excess margin | 0.01 | 0.04 | 0.03 | 0.04 | 0.04 | 0.04 | 0.04 | 0.5% |
| [symbol] EIGHTED AVERAGE SCORE | 3.40 | 5.23 | 9.52 | 9.15 | 8.44 | 7.73 | 7.40 | 100.0% |
| [symbol] EDIT RATING | A1/A | A3/A− | Ba2/BB | Ba1/BB+ | Baa3/BBB+ | Baa3/BBB+ | Baa2/BBB | |
| SIGNED RATING | A/A | A/A | Ba/BB | Ba/BB | Baa/BBB | Baa/BBB | Baa/BBB | |

[symbol]

indicates data missing or illegible when filed

Table 7 points out one additional aspect of method 10: credit ratings may be established based on current, historical, or projected financial data. Additionally, the trends in a hospital's credit rating may be taken into account in method 10 when establishing discount rates. In the example of Table 7, the hospital in question had high ratings in 2002 and 2003, but is projected to have lower ratings in successive years.

Once a hospital's credit rating is established, it may remain the same for some period of time, and thus, need not be recalculated in every iteration of method 10. Generally, a hospital's credit rating would be recalculated for two reasons, first, if new financial data became available, and second, if the rating scale used to rate the hospital changed. As was described briefly above, the credit rating established in task 16 of method 10 would generally be used as an ad hoc rating, and would generally be used only internally by the billing service. The hospital in question may or may not be notified of their rating, and may or may not know that a rating has been determined.

As illustrated in FIG. 1, once the hospital's credit rating is established in task 16, method 10 continues with task 18, in which the billing service establishes a discount rate based on the hospital's credit rating. As used in this description, a “discount rate” refers to a percentage of the total amount owed by a patient that is withheld and not advanced to the hospital by the billing service when the right to collect the debt is purchased by the billing service. The discount rate is based on the hospital's credit rating and will generally be at the discretion of the billing service, although it will usually be a lower percentage for hospitals with higher credit ratings and a higher percentage for hospitals with lower credit ratings. For example, discount rates may range from about 10% to about 20%, with the higher rates being used with hospitals that have lower credit ratings.

Like the credit rating established in task 16, the discount rate established in task 18 may be used in many iterations of method 10, and need not be recalculated for each transaction or each time method 10 is executed. Typically, discount rates would be recalculated when a hospital's credit rating changes, when the billing service's overall policies change, or when there is some other financial reason to make such a change (e.g., if a hospital proves itself in practice to be less creditworthy than its rating would indicate).

It should be understood that no credit rating established in task 16 is necessarily a bar to a particular hospital participating in method 10. In most embodiments, the billing service will have complete discretion over which hospitals it works with and which patient debts it buys from those hospitals. If the billing service does decide not to work with a particular hospital, that decision may be based on the credit rating alone, or based on the credit rating and any other factors that the billing service deems relevant. Generally, however, the billing service will work with hospitals that have lower credit ratings, albeit offering them a higher discount rate.

Method 10 continues with task 20, in which the billing service receives patient information and payment terms from the hospital. As was described above, the patient is informed of how much he or she owes the hospital in task 14, which may be performed before the patient leaves the hospital, although other scenarios will be described below. The hospital may negotiate payment terms (e.g., a fixed payment for a defined number of months) with the patient or, alternatively, the billing service may negotiate payment terms with the patient. The information received by the billing service in task 20 may include such information as the patient's name, gender, address, Social Security number or other government identifying reference, amount owed, and, optionally, information about the hospital stay or services performed. This information may be supplied to the billing service in any number of ways, including on paper or by telephone, although as will be described below in more detail, it is advantageous if there is an automated interface that allows the hospital to communicate the data automatically to the billing service.

Using the information supplied in task 20, method 10 continues with task 22, in which the patient information is used to establish or obtain a patient's credit rating, expected recovery percentage of an individual claim (“Expected Recovery Index” or ERI) or other credit scoring metric. In the United States, several commercial consumer credit bureaus track consumer spending and financial condition and issue a credit score or rating for each consumer, often called a FICO score. The FICO score, its equivalent abroad, an ERI, or another scoring metric, may be used in method 10, as may any other way of gauging a patient's creditworthiness.

Method 10 continues with task 24, in which a reserve is established based on the patient's credit rating, ERI, or other scoring metric. The reserve, like the discount, is a percentage of the total amount owed by the patient that is withheld and not advanced to the hospital when the right to collect the patient's debt is purchased by the billing service. However, the reserve is based on the credit rating of the patient. In one embodiment, the reserve may be from about 10% to about 20% with patients having higher (i.e., better) credit ratings, ERIs or other scoring metrics being assigned lower reserves.

Once the discount and reserve are established, in task 26 of method 10, the hospital is advanced an amount that is equal or substantially equal to the amount owed by the patient, less the sum of the discount and the reserve. The billing service may require that the patient make a payment before the billing service advances any amount to the hospital. For example, assume that Hospital A has a good credit rating and has been assigned a discount rate of 10%. Also assume that Patient X has a good credit rating and has an assigned reserve of 10%. With that discount and reserve, if Patient X has a debt to the hospital of $100, Hospital A would be advanced $80, which is $100−(10% discount+10% reserve). As an alternate example, assume that Patient B, with a slightly lower credit rating and a reserve of 15% owes Hospital A $100. In that case, Hospital A would be advanced $75, which is $100−(10% discount+15% reserve).

Once the hospital has been advanced some amount of money in task 26, method 10 continues with task 28, in which the billing service collects the amount owed from the patient. This may be done in essentially any way in which a financial transaction may be conducted. For example, the billing service may invoice on a monthly basis and the patient may pay by cash or check. However, it is advantageous if the billing service is able to collect from the patient in an essentially passive manner that requires as little action from the patient as possible. In some embodiments, for example, the patient may pay by recurring charge to a credit or debit card, recurring automated clearing house (ACH) debits from a bank account, or some other automatic, recurring mode of payment. In particularly advantageous embodiments, payments may be arranged, changed, or modified directly by the patient through an automated interface, such as a World Wide Web site, or a telephone voice- or tone-response system. Particular systems for carrying out method 10 will be described below in more detail.

In recent years, consumers have become more accustomed to making payments by automatic charge to a credit or debit card, and to controlling, scheduling, and changing those payments through automated machine interfaces. By allowing patients to make medical payments in the same manner, it is believed that patients may find it easier to make the payments. However, task 30 of method 10 illustrates a possible outcome if a patient defaults. Specifically, if a patient defaults (task 30:YES), the billing service may deduct the amount in default from the reserve and/or the next advance paid to the hospital (in addition to the discount and reserve for that transaction), as shown in task 32. Alternatively, the billing service may invoice the hospital for a supplemental reserve in the amount of the default.

If the patient does not default (task 30:NO), the billing service has two main options: it can keep the entire reserve, or it can return some or all of the reserve to the hospital, as shown in task 32. Method 10 concludes with task 36.

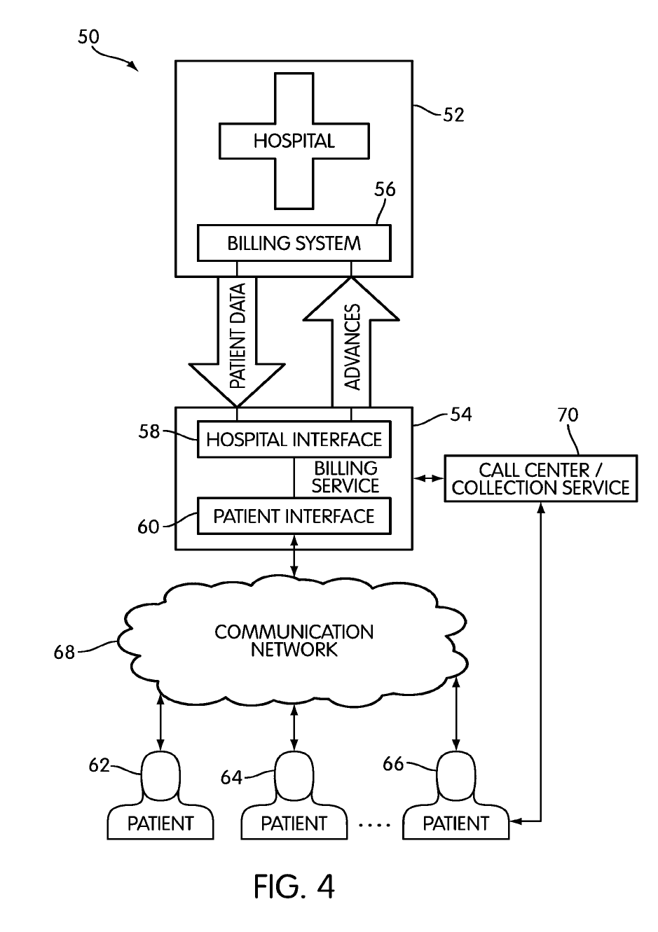

Method 10 may be executed using any number of different types of systems. One exemplary system is indicated generally at 50 in FIG. 4. In system 50, information systems with automated interfaces are used to the extent possible to automate method 10. In system 50, a hospital 52 communicates with a billing service 54, and the billing service 54 acquires the right to collect patient debts from the hospital 52, as was described above. In FIG. 4, only one hospital 52 is illustrated, although billing service 54 may service any number of hospitals and any number of patients simultaneously.

The hospital 52 has a billing or accounting system 56 that tracks and handles patient billing records. That system may be a general purpose computer, a computer system, or an interoperating group of computer systems, that are specially adapted for billing applications. Patient information, including identifying information, contact information, and information on the amount owed, would be transmitted from the billing system 56 of the hospital 52 to the billing service 54. Specifically, the billing service 54 may have a hospital interface 58, a computing system adapted to communicate with the billing systems 56 of the hospitals 52 and to receive patient information from them.

The information may be transmitted from the hospital billing system 56 to the hospital interface 58 of the billing service 54 in a variety of ways. In most embodiments, the communication between the two may be by way of a communication network, either a general communication network, such as the Internet, or a special-purpose network, such as a local or wide area network (LAN or WAN) dedicated to transferring patient information between the hospital 52 and the billing service 54. Generally speaking, communications between the two may be set up in any way known in the art and may be protected in any way known in the art, for example, by encryption.

Depending on the embodiment, the volume of patient debt being purchased by the billing service, and other factors, information transfer may be handled in a variety of ways. In one embodiment, for example, the hospital interface 58 may provide a World Wide Web site or page that allows manual entry of the information, or alternatively, upload of the information in some compatible file format. The hospital interface 58 may also perform some initial data verification functions to confirm, for example, that the data is complete and in the proper format, and has been correctly received, and it may notify the billing system 56 if any data is improperly formatted or should be retransmitted.

If there is a high volume of data flowing between a particular hospital's billing system and the hospital interface 58, data transfer may be by batch transfer of a number of patient records at a time, for example, by File Transfer Protocol (FTP) or upload to a World Wide Web site. The patient data itself may be in a format specified by a data description language such as extensible markup language (XML), or in any other format known in the art, so long as the billing system 56 is capable of formatting the patient data in that format and the hospital interface 58 is capable of receiving and correctly interpreting it.

As shown in FIG. 4, the hospital interface 58 may also be responsible for communicating the amount of advances to the hospital's billing system 56. Generally, after transmission of the patient information and execution of the appropriate tasks of a method such as method 10 to establish the amount of the advance, the hospital interface 58 would notify the billing system 56 of the amount of the advance and then make arrangements, for example, through an ACH, to have that amount of money transferred to the bank accounts of the hospital 52.

The hospital interface 58 essentially provides a means for “back-end” communication between the billing service 54 and its client hospitals 52. As shown in FIG. 4, the billing service 54 also provides a “front end” patient interface 60 (alternatively or in some embodiments, a patient interface server) to interface with patients 62, 64, 66. Although the patient interface 60 and hospital interface 58 are shown separately for ease of description, it should be understood that the two interfaces 58, 60 may be implemented as different software programs or sets of machine-readable instructions in the same physical computer system or set of interoperating systems.

The “front end” patient interface 60 would typically comprise a World Wide Web site or another interactive interface provided over a communication network 68 such as the Internet. By accessing the patient interface 60 with a client device (not shown in FIG. 4), patients would be able to check on the status of their payments, change their contact information, their credit card and/or other banking information, schedule payments, and perform any other customary tasks that are known in the art. The client device may be a general purpose computer, such as a laptop or desktop computer, a smart phone, an Internet appliance, or any other device known in the art that is capable of accessing the patient interface 60. Although the Internet and World Wide Web sites provide a convenient way for patients 62, 64, 66 to perform these tasks, the patient interface 60 may also be implemented as a voice, speech, or tone-recognition telephony system, so that patients 62, 64, 66 can perform tasks over the telephone. The billing service 54 may choose to maintain several different types of patient interfaces 60 concurrently, including, for example, both an Internet-based interface and a telephone-based interface. Message-based interfaces, such as e-mail and SMS text message-based interfaces, may also be implemented. In addition to automated patient interfaces, the billing service 54 may include an e-mail server, a text message server, or another means of implementing unidirectional or bidirectional communication with the patients 62, 64, 66, which may be useful in informing a large number of patients 62, 64, 66 of information.

Although described here as being operated by the billing service 54, the patient and hospital interfaces 58, 60 may be operated by any entity under the aegis and/or direction of the billing service 54. The patient and hospital interfaces 58, 60 may, for example, be physically located at a shared data center operated by another entity. Alternatively, the billing service 54 may contract out the job of setting up and maintaining the hospital and patient interfaces 58, 60.

Additionally, the two interfaces 58, 60, and the other systems described herein, may be implemented in software, in hardware, or in some combination of software and hardware. The term “software” generally refers to a set of machine-readable instructions encoded on a machine-readable medium that is interoperable with a machine to perform certain defined tasks, such as the tasks of a method like method 10.

In system 50, the billing service 54 is able to maximize its efficiency and profit by receiving patient data automatically from hospitals 52, interacting with patients 62, 64, 66, when necessary, through automated interfaces, and collecting debts, when possible, in the form of automatic credit card, debit card, or ACH transactions. However, in some cases, it may be necessary to speak directly with patients 62, 64, 66. This may be necessary, for example, if the hospital 52 did not negotiate a full set of payment terms with the patient 62, 64, 66 prior to discharge, if there are payment problems, or if the patient defaults on an amount owed. In that case, the billing service 54 may operate or contract with a call center/collection service 70 that acts to contact the patients 62, 64, 66 directly and resolve those sorts of problems.

In the description of method 10 and system 50 above, it is assumed that the hospital 52 communicates directly with the patients to identify the amount owed and to set payment terms. However, in many circumstances, the health insurer is an inseparable part of the system and process, and the billing service 54 may operate in cooperation with an insurer.

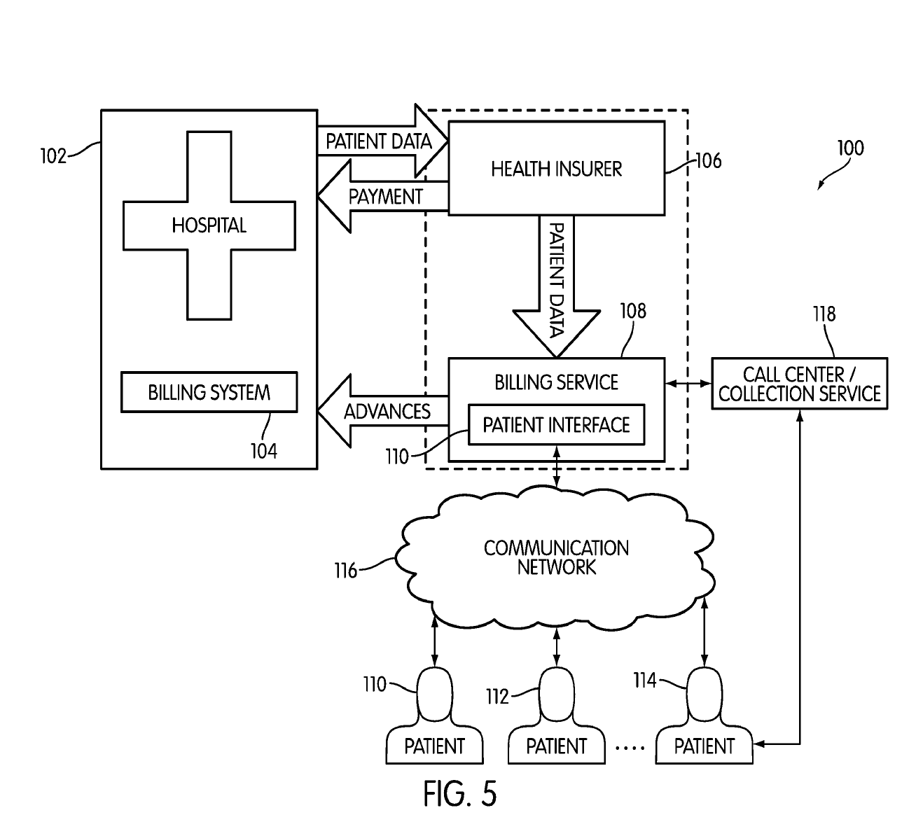

FIG. 5 is an illustration of another system, generally indicated at 100, that may be used to implement methods according to embodiments of the invention. In method 100, those components that are not specifically described may be assumed to be substantially similar to those of system 50 above.

In system 100, a hospital 102 and its billing system 104 communicate with a health insurer 106. The communication between the hospital 102 and its billing system 104 and the health insurer 106 may be by any means known in the art. In some embodiments, communication may be by electronic means over a communication network; in other embodiments, communication may be by non-electronic means. The health insurer 106 performs its typical functions: it receives patient data indicating the patient's diagnosis, the procedures that were performed by the hospital, and the associated costs, decides what is allowable under the patient's particular health insurance contract, and pays the hospital 102 the contractually-defined amount.

In system 100, a billing service 108 operates as an affiliate of the health insurer 106. Prior to hospitalization or the provision of medical services, patients insured by the health insurer 106 agree that their data can be shared with the billing service 108 and that the patient co-pay, co-insurance amount, or any other fees due from the patient may be collected by automatic debit (ACH) or some other automatic means from a credit card or bank account on a prescribed timeframe. Thus, in system 100, patient data, including the amount due from the patient, is passed directly from the health insurer 106 to its affiliate the billing service 108. This information may be transferred from the health insurer 106 to the billing service 108 electronically using any of the methods and systems described above.

Like in system 50, in system 100, the billing service maintains a patient interface 110 which may take the form of a World Wide Web server providing a Web site that patients 110, 112, 114 can connect to through a communications network 116, such as the Internet, using their own client devices. As described above, other types of patient interfaces 110 may be maintained, and the billing service 108 may concurrently maintain several types of patient interfaces 110. The billing service 108 performs the tasks of method 10, insofar as it establishes credit ratings for the hospital 102 and patients 110, 112, and 114, collects from the patients, and advances to the hospital 102 some amount based on the amount(s) owed by the patients 110, 112, 114. As with system 50, the billing service 108 may maintain or be associated with a call center/collection service 118 that handles direct contact with patients when necessary.

In system 100, the presence of the billing service 108 may be essentially invisible to the patients 110, 112, 114, depending on the embodiment. That is, because the billing service 108 is operating as an affiliate of the health insurer 106, it may collect from the patients 110, 112, 114 in the name of the health insurer 106. Alternatively, the billing service 108 may collect from patients 110, 112, 114 in the name of the hospital 102. As with system 50, the patients 110, 112, 114 may be unaware of the credit rating and other tasks performed by the billing service 108.

While the invention has been described with respect to certain embodiments, the embodiments are intended to be exemplary, rather than limiting. Modifications and changes may be made within the scope of the invention, which is defined by the claims.

What is claimed is:

1. A billing method, comprising:
establishing a hospital credit rating by analyzing an existing rating scale and fitting hospital financial data to the existing rating scale;
establishing a discount based on the hospital credit rating;
receiving patient billing data indicating at least patient identifying information and amount owed by the patient;
establishing a patient credit scoring metric for the patient;
establishing a reserve based on the patient credit scoring metric;
advancing the hospital an amount at least approximately equal to the amount owed by the patient less the discount rate and the reserve; and
collecting the amount owed from the patient.

2. The billing method of claim 1, wherein receiving patient billing data comprises receiving patient billing data by means of an automated interface.

3. The billing method of claim 1, wherein establishing a hospital credit rating comprises:
performing a regression analysis of the existing rating scale and existing financial data to identify a relationship between the existing financial data and the existing rating scale;
using the relationship to determine one or more ratings on the existing rating scale for the hospital financial data; and
weighing the ratings to establish the hospital credit rating.

4. The billing method of claim 1, wherein the patient credit scoring metric is a FICO credit score or expected recovery index.

5. The billing method of claim 1, further comprising, if the amount owed is successfully collected from the patient, paying the hospital at least a portion of the amount owed.

6. The billing method of claim 1, wherein collecting the amount owed from the patient comprises collecting one or more installment payments by credit card, debit card, or automated clearing house transaction.

7. A medical billing system, comprising:
a billing service that defines an ad hoc credit rating for a medical provider by analyzing an existing rating scale and fitting medical provider financial data to the existing rating scale, and defines a credit scoring metric for a patient, wherein the billing service receives financial data from a third party indicating an amount owed for medical services and patient data for the patient;
a patient interface server associated with the billing service, the patient interface server providing an interface to the patient through a communications network, the interface indicating the amount owed for medical services, allowing the patient to modify at least some of the patient data, and allowing the patient to enter or edit payment information;
wherein the medical billing system collects the amount owed for medical services from the patient at least substantially automatically using the patient interface server and remits to the medical provider a portion of the amount owed for medical services based on the ad hoc credit rating and the credit rating for the patient.

8. The medical billing system of claim 7, wherein the third party comprises the medical provider.

9. The medical billing system of claim 7, wherein the third party comprises a health insurer.

10. The medical billing system of claim 7, wherein the patient interface server comprises a World Wide Web server.

11. The medical billing system of claim 10, wherein the system includes a second patient interface comprising a voice or tone response system.

12. The medical billing system of claim 7, wherein the patient interface server comprises a voice or tone response system.
